(19) United States
(12) Patent Application Publication
(10) Pub. No.: US 2024/0068900 A1
(43) Pub. Date: Feb. 29, 2024

(54) Automatic or at least semi-automatic system and method for detecting and flagging a leak in roofing

(71) Applicant: SOPREMA, STRASBOURG (FR)

(72) Inventors: Pierre-Etienne BINDSCHEDLER, STRASBOURG (FR); Kent Albert OZCELIK, STRASBOURG (FR); Rémi PERRIN, BOERSCH (FR)

(21) Appl. No.: 18/280,300

(22) PCT Filed: Mar. 3, 2022
(86) PCT No.: PCT/EP2022/055338

§ 371 Date: Sep. 5, 2023

(30) Foreign Application Priority Data
Mar. 4, 2021 (FR) FR2102106

(51) Int. Cl. G01M 3/16; G08B 21/20

(52) U.S. Cl. CPC G01M 3/16; G08B 21/20

(57) ABSTRACT

The invention relates to a method for detecting and flagging a leak in roofing (2), employing a system (1) comprising i) one local detecting and communicating unit for each roofing region (Zi), comprising an elongate sensor and a module (5) for measuring and transmitting at least certain results of the measurements successively carried out, and ii) a management platform (6) configured to receive and process measurements of the modules (5) of various local units managed thereby, and to selectively trigger one or more predetermined actions depending on an evaluation of the received measurements and on an estimation as to whether or not a leak is present, each sensor (4) being installed under the waterproof membrane of the associated roofing region (Zi) and the uplink communication between each local unit and the platform (6) being achieved at least locally through a mode of wireless transmission between the module (5) of the local unit in question and either a local relay terminal, or a base station or even a communication system connected to the Internet.

The present invention relates to an automatic or at least semi-automatic system and method for detecting and flagging a leak in a roof, advantageously making it possible to simultaneously warn a number of actors concerned, namely, for example, the owner(s)/resident(s)/manager(s) of the office or apartment block, the building or the residence, a waterproofing professional and the administrator of the system.

There is currently an unsatisfied demand for a system and a method that are automatic, or at least semi-automatic, for detecting and flagging a leak in a roof, which would make it possible 1) to discriminate the false alerts, 2) by zoning, to locate said leak, by taking account of different factors/parameters and estimating the gravity thereof and the urgency for a possible intervention, 3) simultaneously warning several actors concerned, and 4) having a modular and flexible system structure that makes it possible to adapt to changes to the property portfolio being monitored.

By comparison to the spot detection performed by the current systems, the proposed solution should make it possible to achieve surface monitoring and detection.

Furthermore, the system and the method proposed should require only the implementation of a limited number of components on sites, that are easy to install and incorporate in the roof, when it is being built or redone. In particular, the fact of being able to dispense with complex wiring and assembly operations, or even connection to the electrical mains, is sought. The proposed solution could also be installed without using an electrician (reducing costs—installation just by the roofer).

In accordance with the invention, at least the main aims set out above are achieved by virtue of a semi-automatic or automatic system for detecting and flagging a leak in a roof or at least a part of roof of at least one office or apartment block, building or residence, this system comprising:
a local detection and communication unit for each roof zone or part of roof to be monitored, this unit comprising an elongate sensor, for example in the form of a contact sensor consisting of a ribbon incorporating two conductive lines, and a module for measuring the resistance between these lines and transmitting at least some results of the measurements successively taken, if necessary after preprocessing,
a management platform configured to receive and process the measurements from the modules of the different local units managed by it, and, if necessary, to selectively trigger one or more predetermined actions based on the evaluation of the measurements received and on the estimation of the presence or not of a leak, each sensor being installed under the waterproofing layer of the associated roof zone and the layout configuration of each elongate sensor being adapted to the form of the zone monitored by the local unit considered and the latter performing repetitive measurements at regular intervals, and

the uplink communication between each local unit and the platform being achieved by messages of identified origin, transmitted unconditionally at maximum intervals, and being achieved at least locally by a wireless transmission mode between the module of the local unit considered and either a local relay terminal, or a base station or even a communication system linked to the Internet and present in the office or apartment block, the building or the residence concerned, or in a neighboring construction.

The following description relates to preferred embodiments of the invention, given as nonlimiting examples, and explained with reference to the attached schematic drawings, in which:

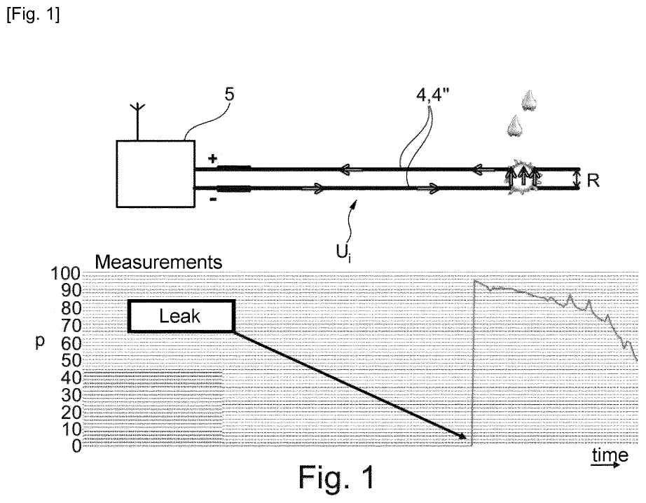

FIG. 1 schematically illustrates the construction and the principle of operation (leak detection) of a local detection and communication unit (Ui) according to the invention, assigned to a roof zone (Zi) or part of roof (2) to be monitored;

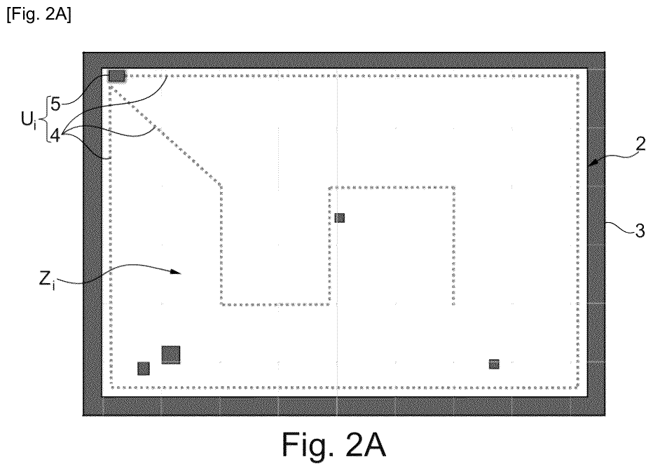

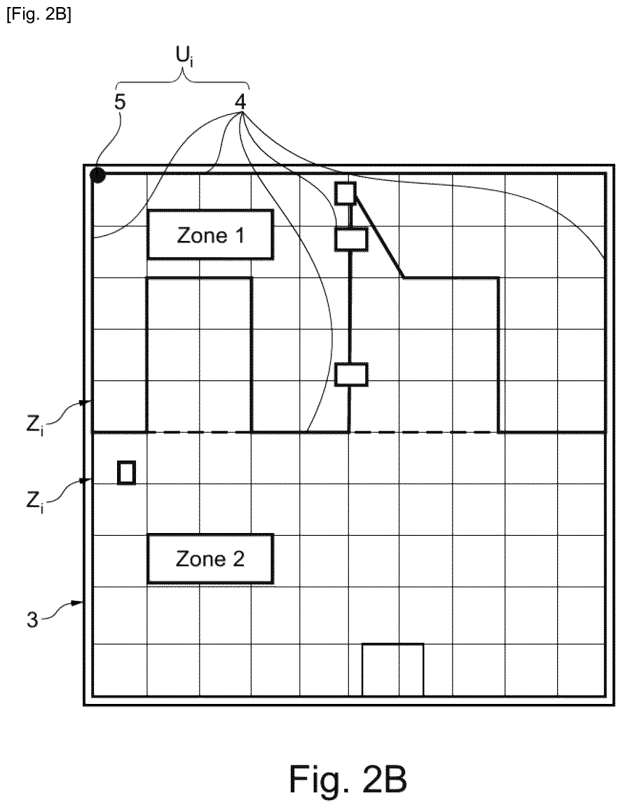

FIG. 2A and

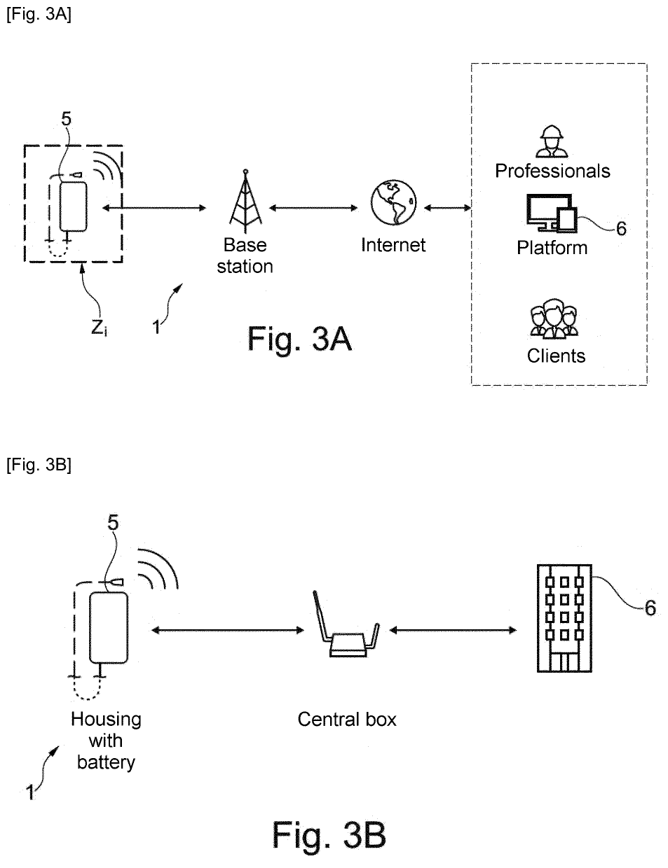

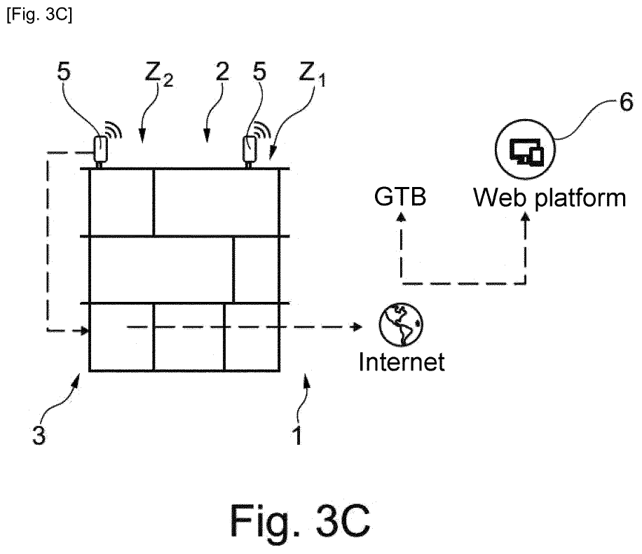

FIG. 2B schematically illustrate by top views two variants of installation of local units in roof zones to be monitored;

[FIG. 3A],

FIG. 3B and

FIG. 3C are symbolic representations of three variant embodiments of a system according to the invention, which differ from one another primarily by the modes of communication between the local units and the platform;

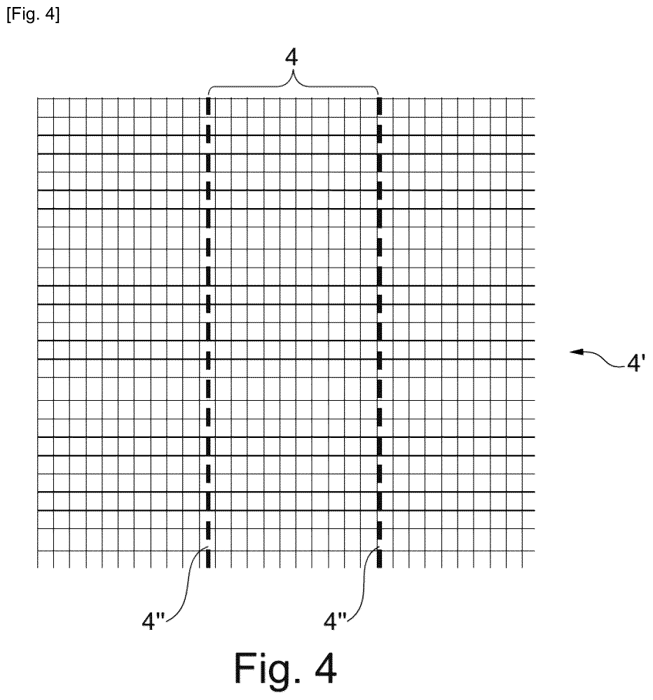

FIG. 4 is a detail view of a possible practical variant embodiment of a contact sensor (4) in the form of a tape (4′) incorporating two conductive lines (4″)— a tape with lines incorporated in a PES fabric, identical wefts—and forming part of a local unit (Ui) implemented within the framework of the invention;

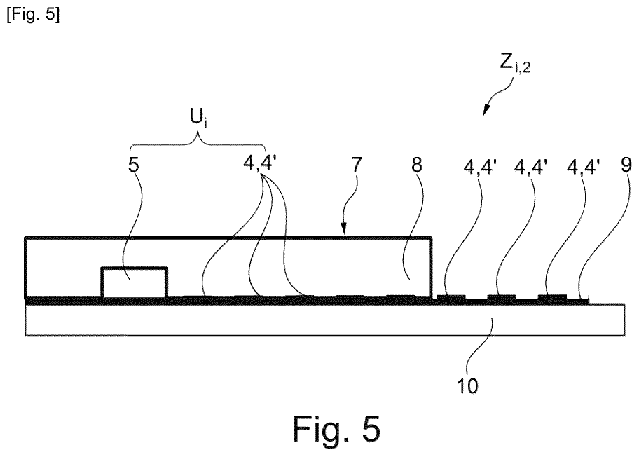

FIG. 5 schematically illustrates, in a cross-sectional view and by way of example, the installation of a unit according to the invention in a roof;

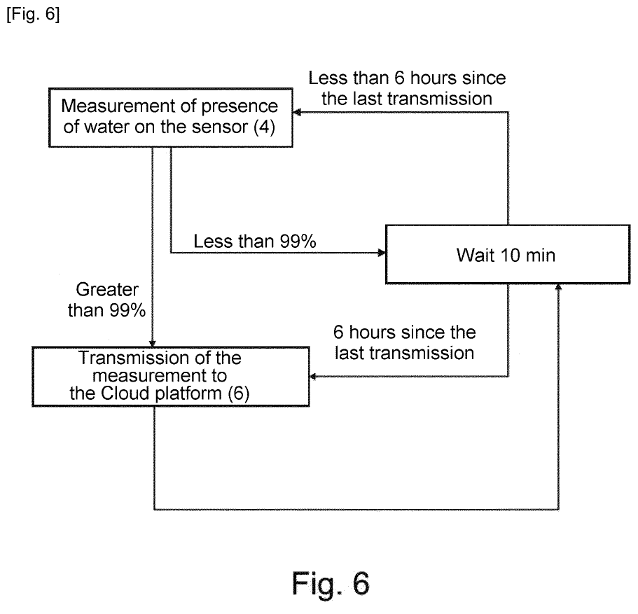

FIG. 6 represents the flow diagram of the routine for controlling the operation of the communication module (5) of a local unit (Ui) according to the invention;

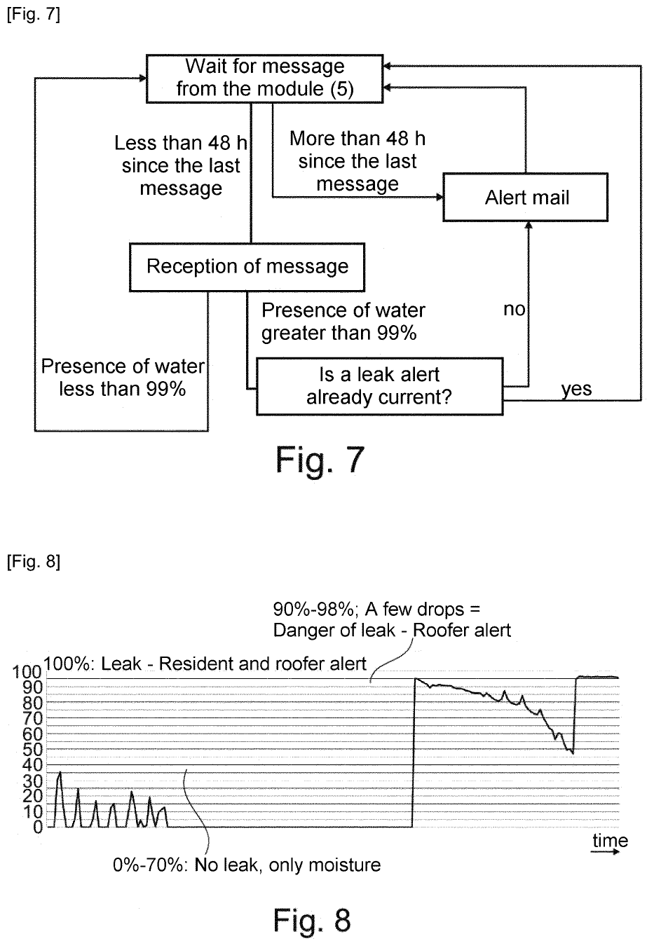

FIG. 7 represents the flow diagram of the routine for communication of the platform (6) with each module (5) of the different local units (Ui) forming part of the system according to the invention;

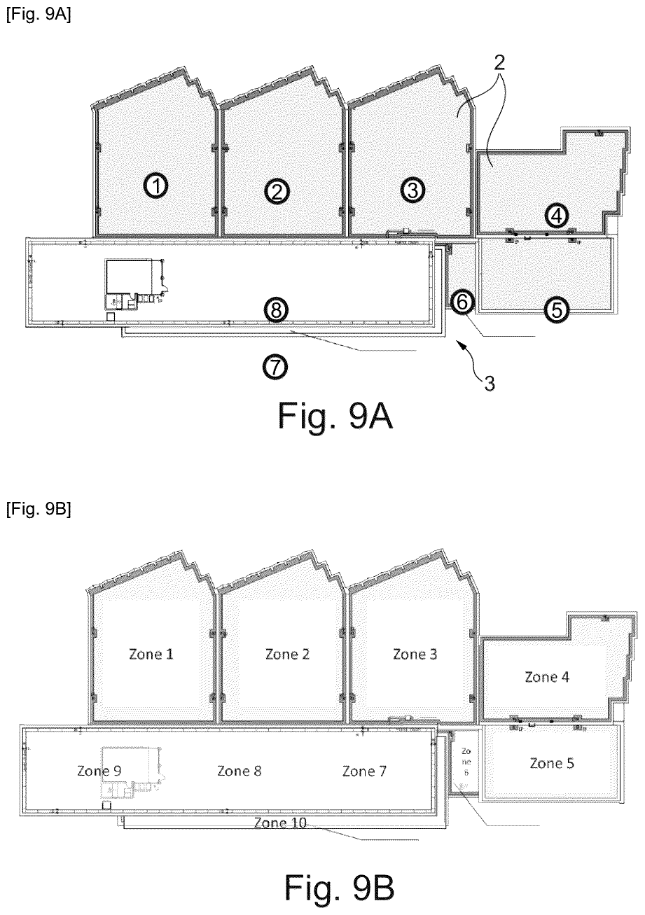

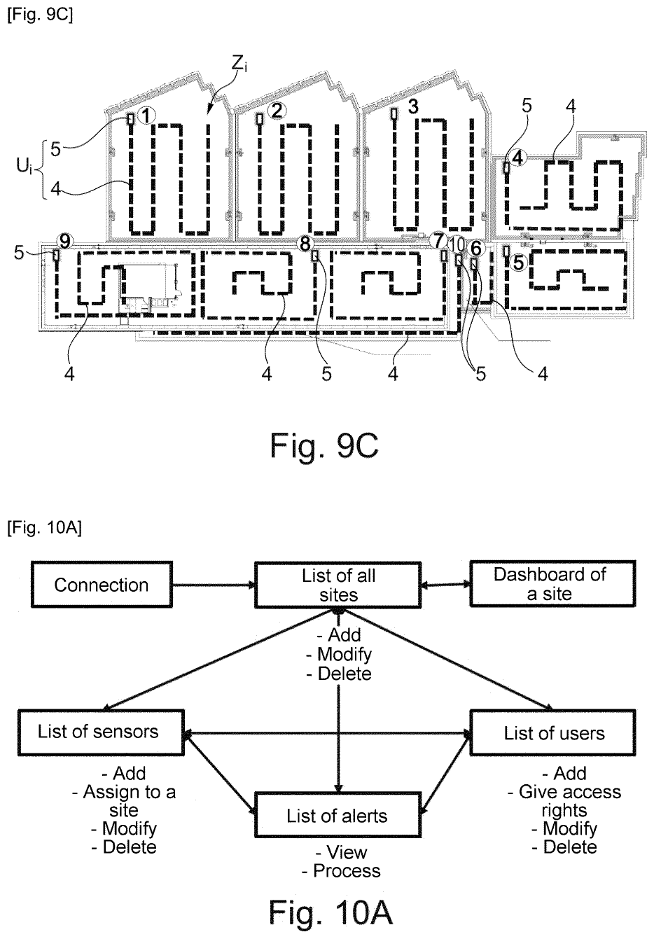

FIG. 8 represents a possible interpretation, automatic by suitable software or visual by an operator, of the curve of the measurement values transmitted successively over time by a local unit (Ui) to the platform (6);

[FIG. 9A],

FIG. 9B and

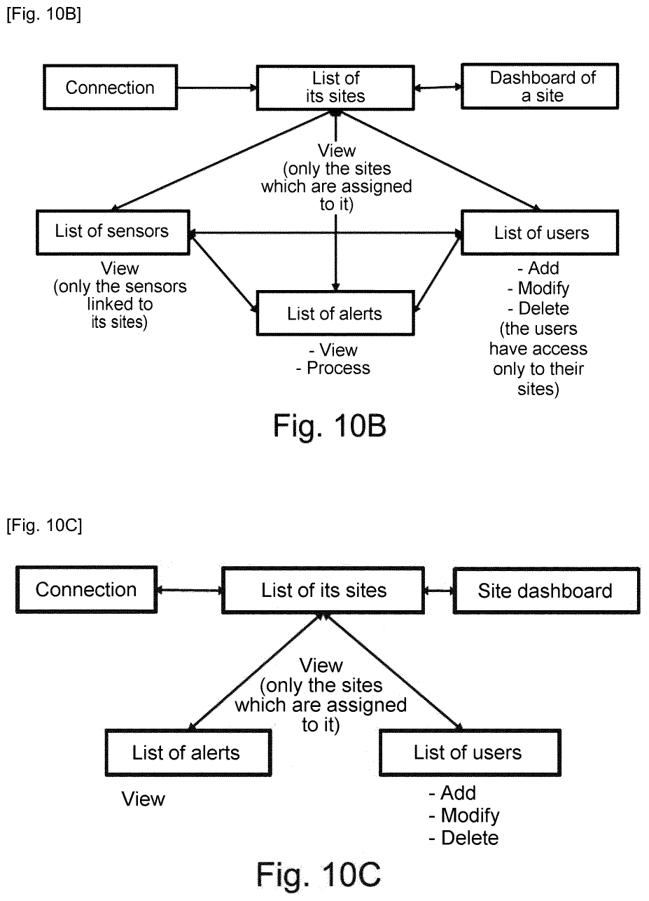

FIG. 9C are top views of roofs of several adjacent office or apartment blocks or parts of roof of a single office or apartment block illustrating the delimitation of zones (Zi) and the installation of the local units (Ui);

[FIG. 10A],

FIG. 10B and

FIG. 10C symbolically illustrate the information accessible and the actions that are authorized on the platform (6) for the different possible users thereof, namely, the administrator of the platform (FIG. 10A), the roofing professional (FIG. 10B) and the resident/owner (FIG. 10C);

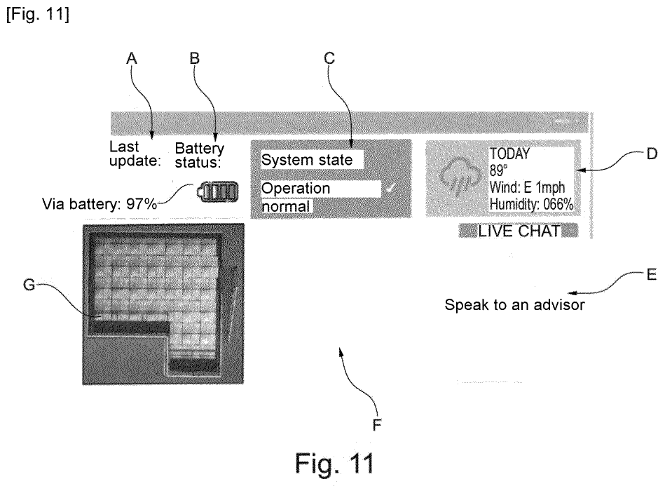

FIG. 11 is an example of a screen copy of a user having accessed the platform (6) to check the situation in a monitored zone (Zi), showing the various information available (here the situation is normal—no leak).

FIGS. 1 to 5 jointly and schematically illustrate, if necessary for some only partially, a semi-automatic or automatic system (1) for detecting and flagging a leak in a roof (2) or at least a part of roof of at least one office or apartment block, building or residence (3). Obviously the system preferentially and centrally monitors a large number of sites of the abovementioned type.

In accordance with the invention, this system for detecting and flagging a leak notably comprises:
a local detection and communication unit (Ui) for each roof zone (Zi) or part of roof (2) to be monitored, each unit comprising an elongate sensor (4), for example in the form of a contact sensor consisting of a ribbon (4′) incorporating two conductive lines (4″) and a module (5) for measuring the resistance (R) between these lines (4″) and transmitting at least certain results of the measurements successively taken, if necessary after preprocessing, and,
a management platform (6) configured to receive and process the measurements from the modules (5) of the different local units (Ui) managed by it, and, if necessary, to selectively trigger one or more predetermined actions based on the evaluation of the measurements received and on the estimation of the presence or not of a leak.

Each sensor (4) is installed under the waterproofing layer (7) of the associated roof zone (Zi) and the layout configuration of each elongate sensor (4) is adapted to the form of the zone (Zi) monitored by the local unit (Ui) considered and the latter performs repetitive measurements at regular intervals. In addition, the uplink communication between each local unit (Ui) and the platform (6) takes place by messages of identified origin (for example each module has a unique identifier), transmitted unconditionally at maximum intervals (predetermined maximum duration between two successive messages), and is achieved at least locally by a wireless transmission mode between, on the one hand, the module (5) of the local unit (Ui) considered and, on the other hand, either a local relay terminal, or a base station or even an analog communication system linked to the Internet and present in the office or apartment block, the building or the residence (3) targeted, even a neighboring structure.

The invention thus provides a system that addresses most of the demands expressed previously, and proposes a solution that is easy to install in new constructions, but also during roofing renovation phases, and do so without involving trades other than the roofing professionals. In addition, because of its elongate, continuous and singular nature, the sensor (4) is easy to manipulate and to lay on site. Furthermore, by a suitable lay or layout scheme, that can easily be determined by the person skilled in the art who has already learned of the invention, the surface coverage in terms of monitoring of the leaks of the monitored zone assigned to the sensor concerned can be optimized in such a way that each point of this zone is located below a maximum distance from said sensor. It is also understood that the data transmitted by a module (5) to the platform (6), apart from the status information which are transmitted regularly, can consist of quasi-raw measurement data, or measurement data analysis results or finalized alert information, all based on the processing and evaluation capabilities incorporated in said module (5).

In accordance with the preferred embodiment of the invention, each module (5) is autonomous, notably in terms of energy supply and operation, and incorporates software means for evaluating resistance (R) measurements and estimating the rate of presence of water (P), these means triggering the immediate sending of an alert message when said rate exceeds a predetermined threshold value. This alert message can possibly also comprise at least some of the measurement data that culminated in the triggering of the alert by the module, specifically for a possible check on the platform.

According to a feature of the invention, the platform (6), controlled by the administrator of the system (1), incorporates software means for determining the probability of the presence of a leak following the reception of an alert message from a module and, if necessary, also taking account of other factors or information, and for conditionally sending a notification to the roofer and/or to the resident(s) and/or to the owner(s) and/or to the property manager concerned, if necessary different notifications depending on the recipients, said platform (6) being accessible for the authorized recipients (duly identified), preferentially with consultable information/data that differ according to the quality of the recipient concerned.

According to another feature of the invention, the platform (6) also incorporates software means for analyzing and evaluating the form of a recorded curve of variation of the rate of presence of water (P) over a period preceding the reception of an alert message indicating that a threshold value for this rate has been exceeded, and/or for assigning a degree of urgency to the actions to be undertaken following a leak detection, and doing so notably according to local weather forecasts.

Furthermore, provision can be made for the platform (6) to be linked to sources of information relating notably to past and current precipitations in the different zones (Zi) monitored by this platform (6), and to the temperatures at the same points.

The collation and the use of these data on the platform make it possible to discriminate the “false” alerts, to broadcast only alerts relating to “true” leaks and to determine the degree of urgency of the intervention to be made if necessary.

Advantageously, each message sent by a module (5) comprises at least one unique identifier corresponding to the unit (Ui) concerned, a datum indicating the rate of presence of water (P) determined on the basis of the measurement of the resistance (R), and expressed for example as a percentage presence, and the date and time of the measurement. This type of message can be sent regularly or, preferentially, only when a rate value greater than a predetermined threshold is recorded (in addition to the routine/status indication messages). The range of transmission of the module (5) will for example be able to be between a few hundreds of meters to several kilometers, even several tens of kilometers, depending on the local area network and the mode of communication with the platform (6).

As FIG. 5 shows by way of example, and when the roof (2) concerned comprises, resting on a support (10), from the inside to the outside, at least one insulating layer (8) and one waterproofing layer (7), the sensor (4) is advantageously disposed under the insulating layer (8), by resting on the support (10) or on a possible vapor barrier layer (9) placed thereon, the module (5) being housed in the thickness of said insulating layer (8) or in a protective housing, specific or not, such as, for example, a skylight.

As FIGS. 2A, 2B and 9C for example show, the or each sensor (4) preferentially comprises a first portion (11) installed so as to extend substantially over the entire perimeter of the zone (Zi) with which it is associated and at least one second portion (11′) extending inside this zone (Zi), preferentially according to a configuration allowing a substantially uniform coverage of the surface of said zone (Zi) in terms of average distance from said sensor (4).

Obviously, other schemes for placement of the elongate sensor can be envisaged, such as, for example, serpentine, with the search for a minimum length and at the same time a uniform and efficient surface coverage, notably with a distance between the sensor (4) and each point of the associated zone (Zi) less than a determined threshold value, chosen based on the desired detection accuracy/speed. As a practical example, the sensor can be arranged in such a way that each meter of sensor covers/monitors 1 m² of roofing zone, with a maximum of, for example, 50 m² monitored per sensor.

In relation to the invention, the operation of each local detection and communication unit (Ui) and the communication between the platform (6) and the modules (5) of these units (Ui) are controlled by suitable control routines, such as, for example, those illustrated respectively in FIGS. 6 and 7.

Also a subject of the invention is a semi-automatic or automatic method for detecting and flagging a leak in a roof (2) or at least a part of roof of at least one office or apartment block, building or residence (3), said method using the system for detecting and flagging a leak described above, and advantageously implementing the control routines of FIGS. 6 and 7.

By virtue of the software means present in the module (5) and above all the platform (6), the sets of operations of measurement, evaluation, possible validation/verification, alert broadcasting/flagging and possibly tracking of the subsequent actions are performed essentially, even totally, automatically using suitable control routines and software, for example of the type emerging from the attached figures and the following description.

Provision can be made for a measurement to be performed at regular intervals (every 10, 20 or 30 minutes, every hour or every 6 hours for example), for an alert message to be sent immediately to the platform (6) if the measurement of presence of water is greater than 90% or 95% for example, or, otherwise, for every hour or every 4 or 6 hours for example for the latest measured values to be transmitted. Thus, an uplink communication is performed from each module to the platform within a predetermined maximum interval, for example resulting from a trade-off between maximum autonomy of the module (possibly powered by a sustainable energy generation device—photovoltaic, wind turbine, etc.) and tight ongoing monitoring.

In relation to the invention, it is for example possible to define 4 alert states for a given zone (Zi) based on the measurements of the associated sensor (4), giving rise to automatic actions on the part of the platform, namely:
“Risk of leak” state: for example P greater than 90%; actions: message to the roofer and to the administrator, resident/owner not alerted.
“Leak” state: for example P close to or equal to 100%; actions: message to the roofer, to the administrator and to the resident.
“Intervention” state: activated by the roofer, makes it possible to indicate that the roofer has knowledge of the leak and that an intervention is underway or planned; actions: message to the resident and deactivation of this state after a determined duration with return to the current state corresponding to the last measurement performed by the sensor concerned.
“Normal” state: when P is less than approximately 70%; action: none.

The features described hereinbelow constitute practical nonlimiting possible embodiments of certain aspects or certain parts of the invention, both for the system and for the method.

In accordance with one possible embodiment of the method according to the invention, the processing and the evaluation of the information originating from the different local units (sensors 4+associated modules 5) can comprise, for a given unit (Ui):
1— The centralization of the resistance R measured on the sensor to a cloud server (in relation to the management platform 6—value of R between 0 and 65 535 ohms)
2— The transformation of the resistance R measured between the two wires as a percentage presence of water P, such as: P=(65 535−R)/R*100
3— (1st variant): alert if P is greater than a defined threshold
4— (2nd variant): analyze the local precipitations (acquired via the Internet) having preceded a possible exceeding of the threshold, as well as the ambient temperature and the form of the curve of P, to determine if it in reality relates to a condensation in the sealing or effectively a true leak (this operation can be automatic or manual).

As an example, the communication/interfacing means between the different parts of the system (1) can take place as follows:
Between sensor (4) and communication module (5): wired connection (see FIG. 1)
Between module (5) and platform (6) (for example: administrator cloud server): LPWAN wireless communication via a public operator, connection via a base station or connection via a central box.

The sensors (4) are preferentially of the contact sensor type, advantageously resistance sensors.

More specifically, each sensor (4) can comprise two conductive wires (4″) made of stainless steel (316L) encapsulated in a polythene braiding (basic strip+tubular housing). The sensor can be incorporated in or associated with, as FIG. 4 shows, a fabric or sheet covering the entire surface of the zone to be monitored.

The installation on site, for the different zones to be monitored, of the units (Ui), can for example proceed as follows (for each unit):
1— placement of the module (5) on the vapor barrier (9),
2— unrolling of the sensor (4) on the vapor barrier according to a layout plan, predetermined or not, with placement of adhesive tape portions at regular intervals for them to be held in position on the vapor barrier,
3-3a— cutting of a notch in the insulation (8) of the size of the module in order for it to be able to be placed on top (FIG. 5—module housed in the insulation), or
4-3b— implementation of a mini-skylight (approximately 25×25 cm) placed on the vapor barrier, in which the module is placed.

The information that can be used on the management platform can for example comprise:
1) Internal information on the unit (Ui)/the module (5):
   unique identifier
   measurement of the presence of water (between 0% and 100%)
   date of the measurement
2) External information (for example web):
   local precipitations
   local temperature
   rain forecasts for the week
3) Information input manually:
   details of the client and of the roofer
   address of the site
   names/numbers of the zones.

The following functionalities/services can for example be proposed with respect to the various actors:
A) For the final client (resident-owner-manager):
   1— Must be alerted in case of water leak by email
   2— Must be able to connect to the management platform and see, in order of importance:
When the leak occurred
Where the leak occurred: name of the zone and plan of the site (when there is one)
Has there been rain just before/after, which would further confirm the presence of a leak?
Is there a risk of rain in the hours/days to come?
B) For the roofing professional (roofer)
1— Must be alerted in case of water leak by email
2— Must be able to connect to the platform to rapidly see:
Where the leak is (what site, what client and what zone)
When the leak occurred
Has there been rain just before/after, which would further confirm the leak?
Is there a risk of rain in the hours/days to come?
3— Must be able to flag to the client that he or she is well informed of the leak C) For the administrator of the system:
1— Must be alerted in case of water leak by email/SMS or the like
2— Must have the same view and the same information as the roofer
3— Must be able to see if the roofer has indeed taken account of the leak and has flagged it to the client via the platform.

The different measurements/information collected can advantageously be viewed in one or more graphs with:
The water measurement curve (between 0 and 100%)
The local rainfall (precipitations in mm)
The local temperature (can be replaced by the rainfall to avoid overloading the graph).

The rainfall and the temperature make it possible to place the water measurement in context and confirm the presence of a leak.

It is for example possible to define four alert states for each zone (Zi), based on the measurements of the associated local unit (Ui):
1) Risk of leak:
Activated when the measurement value is >90%
An email is sent to the roofer and to the administrator (here Soprema), but not to the resident
2) Leak:
Activated when the measurement value is =100%
An email is sent to all the actors (3) concerned
3) Intervention planned/underway:
Can be manually activated by the roofer for all the zones of the site, if the alert state is “Leak”: makes it possible to show to the client that he or she has taken note of the leak.
An email is sent to the resident
Is deactivated automatically after 3 weeks and reverts to the alert state corresponding to the measurement value (leak, risk of leak or normal state)
4) Normal state:
Activated when the measurement value is once again<70%.

The system advantageously also incorporates and uses the weather forecasts.

These forecasts make it possible for the roofer:
To schedule his or her intervention on a day without rain
To evaluate the urgency of the intervention: as long as the roofer has not repaired the leak, each raindrop will pass through the sealing and prolong the duration of the intervention.

The viewing of a site plan (of the zone) can make it possible:
To understand the location of the leak
To find the communication box (to change the batteries, or replace it in case of malfunction)
To view how the sensor ribbon is placed to better analyze the leak.

A log can be provided for each site or zone. It allows the roofer to find all the alerts which have been triggered for the site concerned, with the date and time. The roofer can also enter comments therein, for example the summary of an intervention. The final client can view the log but cannot interact with it.

FIG. 11 shows a possible presentation of a display screen of a user connected to the platform and checking the state of a local unit (Ui).

The following fields/windows can for example be displayed: indication of the latest update on the unit concerned (A), state/level of charge of the battery of the corresponding module (B), state of the system at the unit (in C: normal, malfunction, leak alert, etc.), weather forecasts (D), dialog box (E), site location map (F), diagram of the site with location of the placement of the leak (G). FIG. 11 illustrates a situation in which the system is operating normally and no leak is detected.

Obviously, the invention is not limited to the embodiments described and represented in the attached drawings. Modifications remain possible, notably from the point of view of the construction of the various elements or by substitution of technical equivalents, without in any way departing from the scope of protection of the invention.

1. A semi-automatic or automatic method system for detecting and flagging a leak in a roof or at least a part of roof of at least one office or apartment block, building or residence, said roof or part of roof concerned having, resting on a support, from the inside to the outside, at least one insulting layer and one waterproofing layer, said method implementing a system with steps comprising:
a local detection and communication unit for each roof zone or part of roof to be monitored, this local unit having an elongate sensor, in the form of a contact sensor having a ribbon incorporating two conductive lines and a module for measuring resistance between these lines and transmitting at least certain results of the measurements successively taken, after preprocessing,
a management platform configured to receive and process messages from the modules of the different local units managed by it, and, if appropriate, to selectively trigger one or more predetermined actions based on the evaluation of the messages received and on the estimation of the presence or not of a leak,
each module being autonomous, notably in terms of energy supply and of operation, and incorporating software means for evaluating resistance measurements and estimating the rate of presence of water, these means triggering the sending of an alert message when said rate exceeds a predetermined threshold value,
each sensor being installed under the waterproofing layer of the associated roof zone and disposed under the insulating layer, by resting on the support or on a vapor barrier layer placed thereon, the corresponding module being housed in the thickness of said insulating layer or in a protection housing,
the layout configuration of each elongate sensor being adapted to the form of the zone monitored by the local unit considered and the latter performing repetitive measurements at regular intervals, and
the uplink communication between each local unit and the platform being performed by messages of identified origin, transmitted unconditionally at maximum intervals, and this uplink communication being achieved at least locally by a wireless transmission mode between the module of the local unit concerned, and either a local relay terminal, or a base station or even a communication system linked to the Internet and present in the office or apartment block, the building or the residence concerned, or in a neighboring construction.

2. (canceled)

3. The method as claimed in claim 1, wherein the platform incorporates software means for determining the probability of the presence of a leak following the reception of an alert message from a module and, if necessary, taking account of other factors or information, and for conditionally sending a notification to the roofer and/or to the resident or residents and/or to the owner or owners and/or to the property manager concerned, if necessary different notifications according to the recipients, said platform being accessible for the authorized recipients, preferentially with consultable information/data that differ according to the quality of the recipient concerned.

4. The system method as claimed in claim 3, wherein the platform also incorporates software means for analyzing and evaluating the form of a recorded curve of variation of the rate of presence of water over a period preceding the reception of an alert message indicating that a threshold value for this rate has been exceeded, and/or for a degree of urgency to the actions to be undertaken following a leak detection, and notably according to local weather forecasts.

5. The method as claimed in claim 1, wherein the platform is linked to sources of information relating notably to past and current precipitations in the different zones monitored by this platform, and to the temperatures at the same points.

6. The method as claimed in claim 1, characterized in that wherein each message sent by a module comprises at least one unique identifier corresponding to the unit concerned, a datum indicating the rate of presence of water determined on the basis of the measurement of the resistance, and expressed for example as a percentage presence, and the date and time of the measurement.

7. (canceled)

8. The method as claimed in claim 1, wherein the or each sensor comprises a first portion installed so as to extend substantially over all the perimeter of the zone with which it is associated and at least one second portion extending inside this zone, preferentially according to a configuration allowing a substantially uniform coverage of the surface of said zone in terms of average distance with respect to said sensor.

9. The method as claimed in claim 1, wherein the operation of each local detection and communication unit and the communication between the platform and the modules of these units are controlled by predetermined control routines.

10. The method of claim 1, wherein said method implements predetermined control routines.
